(19) United States
(12) Patent Application Publication
(10) Pub. No.: US 2023/0026557 A1
(43) Pub. Date: Jan. 26, 2023

(54) AN ELECTRIC MACHINE AND METHOD FOR COOLING AN ELECTRIC MACHINE

(71) Applicant: Punch Powertrain N.V., Sint Truiden (BE)

(72) Inventor: Mohammad GALAB, Sint Truiden (BE)

(21) Appl. No.: 17/786,289

(22) PCT Filed: Dec. 18, 2020
(86) PCT No.: PCT/EP2020/087266

§ 371 Date: Jun. 16, 2022

(30) Foreign Application Priority Data
Dec. 20, 2019 (BE) BE 2019/5966

(51) Int. Cl. H02K 1/32; H02K 7/00; H02K 9/19

(52) U.S. Cl. CPC H02K 1/32; H02K 7/003; H02K 9/19

(57) ABSTRACT

An electric machine and method for cooling an electric machine Abstract There is disclosed an electric machine comprising a rotatable shaft comprising an axial channel with a first diameter D1 for receiving cooling fluid; a rotor, arranged to receive the shaft and to be fixedly connected to the shaft; a stator, arranged for mounting over the rotor; wherein the shaft comprises at least one first radial outlet at a first end, and at least one second radial outlet at a second end for allowing cooling fluid to be supplied towards the stator, wherein the channel has a dam section extending from the first end to the second end of the shaft having a second diameter D2 larger than the first diameter D1.

### FIELD OF THE INVENTION

The invention relates to an electric machine and to a method for cooling an electric machine.

### BACKGROUND TO THE INVENTION

Electric machines generate heat when in use. Electric generators and electric motors in particular generate a certain amount of heat which may determine the power an electric generator or an electric motor can supply. Optimizing heat dissipation is therefore important in many aspects, and has particularly grown in interest with the introduction of electric motors in electric or hybrid vehicles. Use of an electric motor in an electric or hybrid vehicle is subject to increasing requirements on torque and/or power generation. To meet these increasing requirements, effective cooling of the electric motor is needed. An electric motor can for example be a switch reluctance motor, an induction motor, a permanent magnet synchronous motor or any other type of electric motor having a rotor and a stator.

Heat is generated by a number of reasons. The stator, for example, comprises stator windings, usually made of copper, connected to a power source in a configuration that allows a turning magnetic field to be formed. The heat generated by the resistance of the copper windings can be a large contributor to the total heat generation of the electric motor. The rotor can comprise a laminated iron core mounted on the shaft. In operation, the rotational magnetic field induces eddy currents in the iron core of the rotor. The energy of these eddy current also may dissipate in heat and may be a contributor to the total heat generation, even when the core is properly laminated to prevent eddy currents as much as possible. Eddy currents might also appear in the shaft if they can form a closed loop, usually through the bearings and the mass. Another part of heat generation may be caused by mechanical friction, for example in the bearings or due to an imbalance and/or misalignment of the shaft.

Cooling of the electric machine can be done through conductive cooling. In conductive cooling the heat generated by the electric machine is naturally dissipated through structural components of the electric machine. For example, by providing ribs to the exterior of the electric machine.

Air cooling can also be used for cooling of the electric machine. Typically, a vent can be installed at the opposite side of the output shaft of the motor for blowing air over the electric motor.

Further, the use of fluid for fluid cooling of an electric machine can be possible. Cooling channels may then be provided in parts of the electric machine and cooling fluid flows through the channels, thus absorbing heat from the electric machine and removing the absorbed heat by flowing out of the electric machine. Fluid cooling can be combined with air cooling and/or conductive cooling to achieve optimized cooling while keeping energy costs to a minimum.

It is known to provide cooling channels in the rotor, and providing openings in the channel to allow the cooling fluid to leave the cooling channel towards the exterior of the rotor. Cooling of the stator coils may thus be envisaged in addition to cooling of the rotor by the liquid in the channel. However, when multiple holes are provided, a relatively big fraction of the cooling fluid flows through the first hole it passes due to centrifugal forces acting on the cooling fluid, and too few cooling fluid reaches the subsequent holes, not resulting in an efficient cooling of the stator coils. The inefficient division of cooling fluid over multiple holes increases with increasing rotational speed of the rotor. Also, the pressure decrease over the channel can be relatively high, resulting in inefficient cooling as well.

So, there is a need for improving the heat dissipation of an electric machine, in particular of the stator of the electric machine.

### SUMMARY OF THE INVENTION

It is an object of the invention to provide for an electric machine and a method for cooling the electric machine that obviates at least one of the above mentioned drawbacks.

More particularly, it is an object of the invention to provide for an improved cooling method for an electric machine. Even more particularly, it is an object of the invention to provide for an improved cooling method for an electric machine used in an electric or hybrid vehicle.

According to an aspect there is provided an electric machine comprising: a rotatable shaft comprising an axial channel with a first diameter for receiving cooling fluid, a rotor, arranged to receive the shaft and to be fixedly connected to the shaft, a stator, arranged for mounting over the rotor. Typically, there is an air gap between the stator and the rotor. The stator is stationary mounted, and can for example be fixedly mounted to a casing of the electric machine. The shaft comprises at least one first radial outlet at a first end, and at least one second radial outlet at a second end for allowing cooling fluid to be supplied towards the stator. The channel has a dam section extending from the first end to the second end of the shaft having a second diameter larger than the first diameter. By providing the dam section having a larger diameter than the cooling channel, the cooling fluid is distributed more evenly over the first and second outlets. The cooling fluid leaving the radial outlets is directed towards the ends of the coil windings of the stator. Typically, the stator coil windings have ends wherein windings turn direction and return towards the stator. These ends are usually outside of the stator housing or stator jacket. By splashing these coil winding ends with the cooling fluid coming from the outlets of the rotor shaft cooling channel, the coil winding ends can be cooled as well. In particular, when both coil winding ends are supplied with approximately equal fractions of cooling fluid, an effective and efficient cooling can be obtained. This contributes to an efficient cooling of the electric machine in the operational conditions of the rotor from low rotational speed to high rotational speed of the rotor.

In particular, due to the increase in diameter of the cooling channel at the dam section the flow pattern of the cooling fluid changes, resulting in a more even distribution of the cooling fluid in axial direction. The diameter increase of the dam section has an influence on how the cooling fluid is divided over the radial outlets. The change of flow after the first end results in less fluid flowing through the first outlet and more fluid flowing remaining in the channel, thus allowing more fluid to reach the outlet at the second end.

The dam section can moreover result in an increase in the total amount of cooling fluid storable in the electric machine at a given moment due to the increase in diameter. The dam section can therefore act as a transmission oil reservoir as oil layers of a certain thickness can be formed in the dam section. The dam section can therefore allow for a decrease in cooling fluid storage space needed in a cooling fluid circuit.

Contrary to the prior art conventional electric machines, having a rotor shaft with a constant diameter, the cooling fluid in the electric machine according to the invention may not experience the back pressure as in the conventional rotor shaft. When a conventional electric rotor rotates at high rotational speeds, due to the high centrifugal forces, the cooling fluid entering into the motor shaft cooling channel experiences back pressure, resulting in that most of the cooling fluid leaves the cooling channel via the first radial outlet, and only very few cooling fluid will reach the second radial outlet at the other end of the cooling channel. So, there is no equal distribution of cooling fluid leaving the first and the second radial outlets and the second radial outlet may have rather limited splashing cooling fluid. By providing the dam section having a larger diameter than the cooling channel, the back pressure is reduced, in particular at high rotational speeds, and the there is more balanced cooling fluid distribution between the first radial outlet and the second radial outlet, thus an improved and/or more effective and/or more efficient heat dissipation of the stator windings is possible.

Advantageously, the dam section may extend over the shaft along a length approximately equal to the length of the stator. When the dam section extends along a length approximately to the length of the stator, the outlets are positioned near a first end of the stator and near a second end of the stator. This allows the outlets to splatter cooling fluid on the end turns of the windings of the stator. This may achieve a higher heat dissipation than when the cooling fluid is splattered on the stator housing or stator jacket encompassing the stator winding coils. Advantageously, the at least one radial outlet is positioned at one end of the dam section and the at least one second radial outlet is provided at another end of the dam section, such that the dam section extends from the at least one first radial outlet to the at least one second radial outlet. Multiple radial outlets can be provided at the first end and/or at the second end. The multiple radial outlets are preferably equally distributed radially. By providing the dam section between the first radial outlets and the second radial outlets, the first end and the second end of the rotor shaft can remain unchanged and, as such, the shaft can maintain its conventional end connections. Over the length at which the dam section is provided to the cooling channel inside of the shaft, it might be that the outer diameter of the shaft may become larger. However, this is not necessary, as sometimes, the wall of the shaft may be sufficiently thick that a dam section can be accommodated. When the outer diameter of the shaft indeed may increase due to the provision of the dam section, there is usually sufficient space between the rotor shaft and the rotor such that the dimensions of the rotor need not to be changed. Typically, the diameter increase of the dam section is between about 3 mm and about 15 mm, advantageously about 10 mm, resulting in an increase in radius of about 5 mm.

Advantageously, the dam section may further comprise at least one fin, preferably a set of fins, arranged inside of the channel. The fins may extend radially from the wall of the dam section radially inwardly. By providing the fins, the flow of the cooling fluid is influenced such that fluid is guided towards the second end of the dam section to exit via the at least one second radial outlet. For example, the flow of the cooling fluid can be more turbulent thus increasing the cooling of the magnets in the rotor. Due to the increase in diameter, the turbulence may increase, so the pressure drop over the axial length of the cooling channel may decrease, thus resulting in a more efficient cooling, both of the rotor as well as of the stator coil winding turns. By providing the at least one radial fin, the cooling of the rotor magnet may become more effective clue to turbulence phenomena induced by the radial fins extending axially.

The set of fins may, like the change in diameter caused by the presence of the dam section, alter the flow of the cooling fluid. This alteration results in less fluid flowing through the first outlet and more fluid flow remaining in the channel, thus allowing more fluid to reach the at least one second outlet at the second end.

Advantageously, the fins of the set of fins are approximately evenly distributed radially. As such, the cooling fluid can be about evenly distributed over the cross-section of the channel such that cooling fluid may about evenly reach the radial outlets that are radially distributed over the wall of the dam section. Additionally, the distribution of the fins may increase the turbulence of the cooling fluid and thus may reduce the pressure decrease over the channel. Thus, the cooling of, also, the magnets of the rotor, may be more efficient.

Advantageously. the set of fins may extend axially over at least a part of the length of the dam section, preferably over almost the entire length of the dam section. By extending the fins axially over, almost, the length of the dam section, the turbulence of the cooling fluid in the channel can be created over about the length of the channel, thus further increasing the cooling efficiency. The radial fins may be arranged in a staggered or zig-zag configuration, may have an helical angle with respect to a longitudinal axis of the cooling channel. Advantageously, the fins can be arranged to be inserted through slits in an outer wall of the dam section. Inserting the fins through, preferably prefabricated, slits in the outer wall of the dam section may allow for a more easy assembly and more cost-effective production instead of, for example, fabricating an internally finned or machined shaft in one piece.

Advantageously, the set of fins comprises between 8 and 15 fins, preferably 12 fins. By providing such an amount of fins, the inventors found that this gave the most optimal heat transfer coefficient in the magnets of the rotor improved in the maximum operating condition, thus a more efficient cooling of the stator winding turns can be obtained. It appeared that an improvement of up to 40% of the heat transfer coefficient of the rotor was possible by such a number of fins.

Advantageously, the dam section may further comprise multiple sets of fins, arranged axially behind each other, each having an angular displacement with respect to the adjacent set. By providing such a configuration, more turbulence of the cooling fluid in the channel shaft might be obtained, thus a more optimal heat dissipation of the rotor might be obtained.

According to an aspect, there is provided an electric or hybrid vehicle transmission comprising an electric machine as described hereinabove. The channel of the rotatable shaft is advantageously arranged for connection to a cooling system of the electric or hybrid vehicle transmission to allow a cooling fluid flow into the channel. As such, a closed cooling circuit can be provided in the transmission, in which the cooling fluid may flow into the channel and may be dissipated towards the stator winding turns through the at least one first outlet and the at least one second outlet. The cooling fluid thus dissipated can be collected in a sump and be re-used in the cooling of the transmission

According to an aspect, there is provided a method for cooling of an electric machine, including: providing an electric machine having a rotor and a stator mounted over the rotor, providing a shaft fixedly connected to the rotor, providing at least one first radial outlet at a first end of the shaft and at least one second radial at a second end of the shaft. The at least one first radial outlet and the at least one second radial outlet are provided on a dam section of the rotor shaft having an increased diameter, such that cooling fluid flows out of the at least first outlet and the at least second outlet towards the stator for cooling ends of the stator windings.

### BRIEF DESCRIPTION OF THE DRAWING

FIG. 1 shows a schematic cross section of an electric machine according to aspects of the invention.

FIGS. 2A, 2B and 2C show an isometric views of three possible fin configurations.

FIG. 3 shows a flowchart of a cooling fluid circuit.

### DETAILED DESCRIPTION

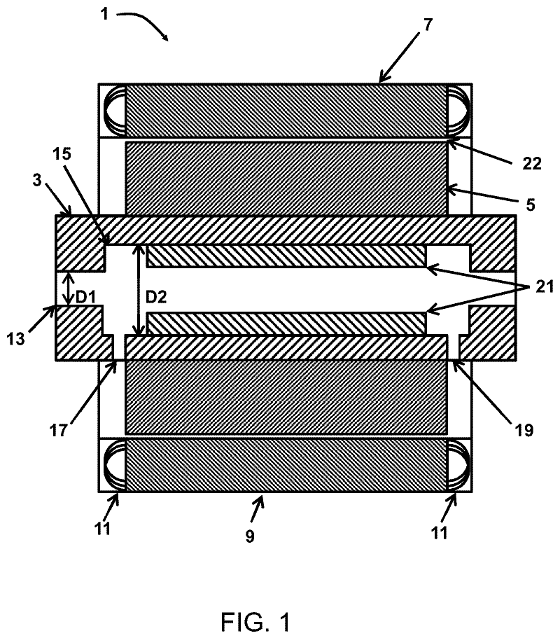

FIG. 1 shows a schematic cross section of an electric machine 1 comprising a shaft 3, a rotor 5 and a stator 7. The stator 7 can be fixedly connected to the surroundings, e.g. bolted to a motor casing, or the a mounting flange of the gear unit, not shown. The rotor 5 is fixedly connected to the shaft 3. The rotor 5 can for example be connected to the shaft 3 by interference fit or by a shaft key way. The shaft 3 and rotor 5 are rotatably mounted in the stator 7, for example by using bearings, not shown. An air gap 22 remains between the stator 7 and the rotor 5. The stator 7 can comprise a coiled, main stator part 9, and winding ends 11 at both sides of the main stator part 9. The shaft 3 may comprise an axial channel 13 with a first diameter D1. The channel 13 further comprises a dam section 15 with a second diameter D2. The dam section 15 extends axially over a part of the length of the channel 13, advantageously between a first end and a second end of the channel 13. The dam section 15 is preferably arranged such that it provides for an abrupt, almost discrete, increase in diameter from diameter D1 of the channel to diameter D2 of the dam section. As such, a dam section transverse wall, is approximately radially oriented. Alternatively, the dam section can provide for a more smooth transition from diameter D1 to diameter D2, wherein the dam section transverse wall may be oblique with respect to a radial direction.

The channel 13 further comprises at least one first radial outlet 17 and at least one second radial outlet 19. In this cross-section, a single first radial outlet 17 and a single second radial outlet 19 is shown, but multiple first and second radial outlets 17, 19 can be provided that may be evenly distributed over the circumference of the channel 13. Preferably, the first radial outlets 17 are arranged at the same axial position at a first end of the channel 13, and the second radial outlets 19 are arranged at the same axial position at a second end of the channel 13.

By providing the dam section 15 between the first radial outlets 17 and the second radial outlets 19, the first end and the second end of the rotor shaft 3 can remain unchanged and, as such, the shaft 3 can maintain its conventional end connections. Over the length at which the dam section 15 is provided to the channel 13, it might be that the outer diameter of the shaft 3 may become larger. The air gap 22 shown between rotor 5 and stator 7 is usually sufficient such that the dimensions of the rotor 7 need not to be changed when the outer diameter of the shaft 3 indeed may increase due to the provision of the dam section 15. Typically, the diameter increase of the dam section 15 is between about 3 mm and about 15 mm, advantageously about 10 mm, resulting in an increase in radius of about 5 mm.

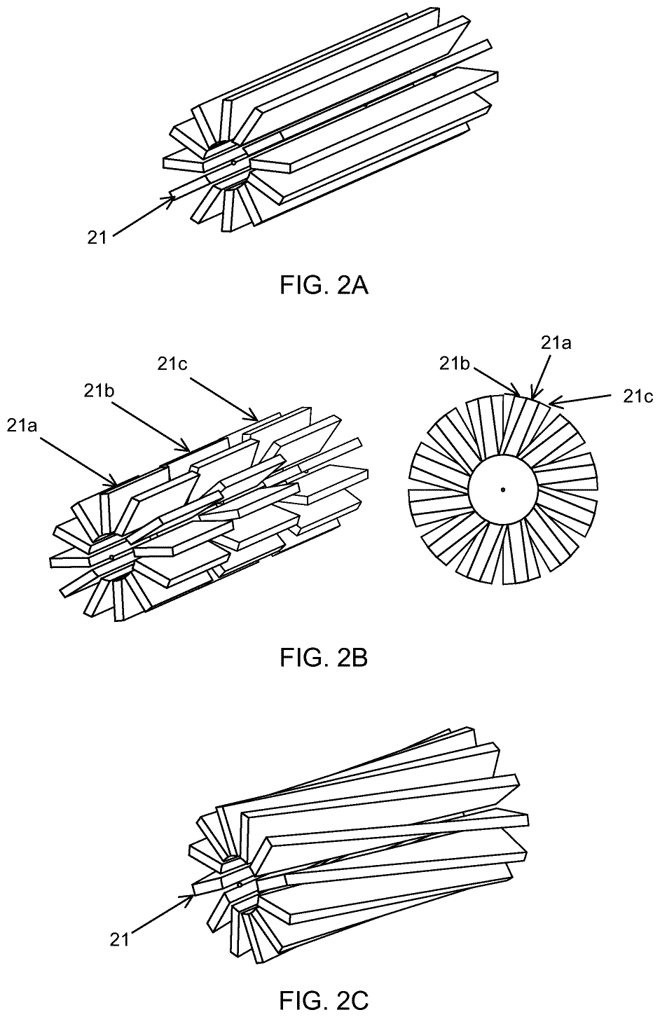

The channel 13 further comprises a set of fins 21. Here, the fins 21 extend over approximately the entire length of the dam section 15, but the fins 21 can be shorter as well. Alternative configurations of the fins are also possible and are shown in FIGS. 2a, 2b, 2c. Advantageously, the fins are mounted to an inner wall of the dam section and extend radially inwardly, such that an inner end of the fins is a free end and a radially outer end of the fins is fixed to the shaft. Preferably, the wall of the shaft is provided with predefined slits through which the fins can be inserted. An outer end of the fin can then be fixed in the slit and/or to the shaft. Various well known possibilities are available for fixating the fin to the shaft, e.g. bolting, welding, clamping, etc. The cooling fluid flows through the cooling channel and comes in contact with the fins 21. Convection heat transfer occurs between the cooling fluid and the fins 21. The convection heat transfer increases by turbulence created by the fins 21, thereby improving the cooling efficiency of the cooling fluid. Conduction radial heat transfer occurs from the shaft 3 to the fins 21 in radial direction, and further from the shaft 3 to the rotor 5 there is conductive heat transfer. When the rotor is a laminated steel rotor with magnets placed inside the laminated steel rotor, further conductive heat transfer occurs from the magnets to the laminated steel rotor. So, the fins 21 also provide for an improvement in conductive heat transfer from the magnets, via the rotor to the shaft and to the fins. Further, the radial outlets provide for splashing of cooling fluid onto the stator winding ends thereby providing for a forced cooling of the stator winding ends. By an improved and more equal distribution of the cooling fluid over the first and second radial outlets, cooling of the stator winding ends is improved as well. So, the dam section with the radially extending fins, provides for an improved and/or more efficient and/or more effective cooling of the rotor and stator.

During operation, the shaft 3 and rotor 5 turn at high speeds with respect to the stator 7. In electric motors, motor speeds over 16.000 rpm are not exceptional. Heat is generated due to several causes in the stator 7, the rotor 5 and the shaft 3. In particular at maximum operational conditions, or when the motor is to operate for a longer time on certain operational conditions, insufficient cooling impairs the efficiency and power of the motor. With electric motors becoming more present in automotive vehicles, such as electric and/or hybrid vehicles, more power and/or torque is being demanded of such an electric motor. With such higher power and/or torque demands of the electric motor, efficient cooling, also at maximum operational conditions or at other operational conditions becomes more important.

To cool the electric machine 1, cooling fluid can be pumped into the channel 13. When in the channel 13, the cooling fluid absorbs heat from the shaft 3 and the rotor 5, mainly through conductive heat transfer from the rotor 5 to the shaft 3 and through conductive and/or convective heat transfer from the shaft 3 to the cooling fluid. As such, the magnets in the rotor 5 can be cooled. When the cooling fluid reaches the first outlet 17, fluid pressure and centrifugal force guide part of the cooling fluid through the first outlet 17. The remaining of the cooling fluid continues on through channel 13. In the first outlet 17, the cooling fluid gains velocity due to the centrifugal force. The cooling fluid exits the first outlet 17 to splash against the winding end 11 of the stator winding coils. The rest of the cooling fluid may keep flowing, while absorbing heat from the shaft 3, towards the second outlet 19 where it may enter the second outlet 19 in the same manner as the cooling fluid in the first outlet 17 and may splash onto the other winding end 11 of the stator winding coil. Previously, the part of the cooling fluid exiting through the first outlet 17 made up for the majority of the cooling fluid pumped into the channel 13, leaving too few cooling fluid for the second outlet, resulting in poor cooling efficiency. The increase to the diameter D2 at a first end of the dam section 15 and, in some examples, the fins 21 may result in an altered flow pattern and possible more turbulence in the vicinity of the first outlet 17 and/or over the length of the dam section 15. A possible increase in turbulence caused by the increase to the diameter D2 and the fins 21 may also result in an increase in heat being transferred to the cooling fluid going through the shaft 3 by convective heat transfer.

As a result of at least the influence of the increase in diameter, the cooling fluid leaving the first and second outlets can be more equally divided over the first outlet 17 and the second outlet 19. An improved heat dissipation for the stator winding turns 11 can thereby reached. Also, due to the increased turbulence of the cooling fluid in the channel and/or the dam section cooling of the rotor 5, in particular of the magnets of the rotor 5, may be improved as well. The fins 21 may increase the contact surface between the shaft 3 and the cooling fluid, which may increase the heat transfer between the shaft 3 and the cooling fluid. The fins 21 may furthermore increase the turbulence of the cooling fluid in the dam section 15 and/or the channel. Due to an increased turbulence, the decrease of the pressure over the axial length of the dam section 15 and/or the channel may be less, thus resulting in more evenly distribution of liquid leaving via the at least one first outlet 17 and via the at least one second outlet 19. Contrary to the prior art, with this dam section a more or less equal amount of cooling fluid, such as cooling oil, comes out of the first and second radial outlets 17, 19, while in the prior art arrangement, without the dam section, more cooling fluid leaves via the first outlet than via the second outlet resulting in poor cooling efficiency.

Cooling fluid that left the electric machine might be collected in a sump and be re-used in the cooling of the electric machine.

FIGS. 2A, 2B and 2C show an isometric view of three possible fin configurations. FIG. 2A shows one straight set of fins 21, here comprising 12 separate fins equally distributed over a circumference of the dam section and/or channel. The inventors found that a number of between about 8 and about 15 fins provides for the most optimal cooling efficiency. The fins may provide for an increase in turbulence of the cooling fluid flow thus resulting in a decrease in the pressure drop over the axial length of the dam section and/or channel, providing for an increased cooling efficiency of the rotor as well as for an improved distribution of outlet flow via the first and the second outlets.

FIG. 2B shows an isometric view and a view along an axial axis containing three separate sets of fins 21a, 21b, 21c. The view along the axial axis shows a slight offset between the three sets of fins 21a, 21b, 21c. This offset has influence on the turbulence, possibly resulting in an even more equal division of the cooling fluid between the first outlet 17 and the second outlet 19. The view along an axial axis also shows that the fins do not necessarily need to be aligned in a radial manner, i.e. the fins aren't necessarily oriented along a normal of the outer diameter of the channel 13. The angle over which the sets of fins may be offset can be about 5 deg to about 45 deg, advantageously over about 30 deg. By staggering subsequent sets of fins, turbulence of the liquid flow can be increased more.

FIG. 2C shows an isometric view of a helical set of fins 21. This helical configuration also has influence on the turbulence, likely an increased turbulence, that may result in an even more equal division of the cooling fluid between the first outlet 17 and the second outlet 19 and/or a more efficient cooling of the rotor.

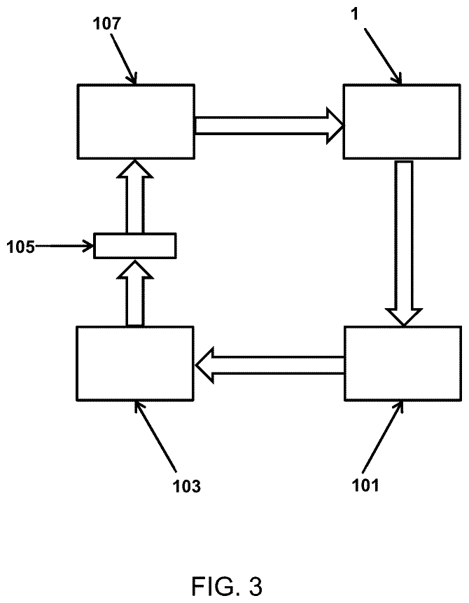

FIG. 3 shows a flowchart of a cooling fluid circuit. A pump system 107 pumps the cooling fluid in the electric machine 1. After making its way through the electric machine 1, the cooling fluid is usually collected in a sump 101. After the sump 101 the cooling fluid might pass a heat exchanger 103, where the cooling fluid might exchange heat with, for example, air provided by an air intake at the front side of the vehicle or any other heat exchanging medium. After the heat exchanger 103 the fluid can optionally pass a cooling fluid condition monitoring device 105, which can, for example, notify the driver when the quality of the cooling fluid has degraded below a certain threshold. Afterwards the cooling fluid may arrive back at the pump system 107. Each of the components in FIG. 3 can also function as a cooling fluid reservoir, or a separate cooling fluid reservoir can be present.

The invention relates to an electric machine comprising, a rotatable shaft comprising an axial channel with a first diameter for receiving cooling fluid, a rotor, arranged to shaft and to be fixedly connected to the shaft, a stator, arranged for mounting over the rotor wherein the shaft comprises at least one first radial outlet at a first end, and at least one second radial outlet at a second end for allowing cooling fluid to be supplied towards the stator and stator end winding. when shaft rotates with different rotating speeds from lower rotational speeds to higher rotational, and spray oil to stator end winding with respective centrifugal forces. Both end windings of the stator windings achieve equal spraying cooling with the cooling chamber—also called lube reservoir—beneath the rotor shaft. The channel has a dam section extending from the first end to the second end of the shaft having a second diameter larger than the first diameter to form lube dam. The invention further relates to a hybrid or electric transmission and to and to a method for cooling an electric machine. The rotor shaft, laminated motor and magnets are also cooled by turbulence phenomena created by radial inwards fins. Forced convection cooling is achieved by radial inward fins when shaft rotates with higher rotational speed. Higher rotational speeds cooling is difficult to achieve, but this can be done by radial inwards fins with different configurations such as in-line fins, helical fins and staggering pattern fins in an effective manner. Forced convection cooling of the stator windings is achieved by equal spraying of oil through the radial holes of the rotor shaft for all rotating speeds. Equal spraying of radial holes of motor shaft is achieved by the cooling chamber—lube reservoir—beneath rotor shaft.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

1. An electric machine comprising:
a rotatable shaft comprising an axial channel with a first diameter for receiving cooling fluid;
a rotor, arranged to receive the rotatable shaft and to be fixedly connected to the rotatable shaft;
a stator, arranged for mounting over the rotor;
wherein the rotatable shaft comprises at least one first radial outlet at a first end, and at least one second radial outlet at a second end for allowing cooling fluid to be supplied towards the stator, wherein the axial channel has a dam section extending from the first end to the second end of the rotatable shaft having a second diameter larger than the first diameter.

2. The electric machine according to claim 1, wherein the dam section extends over the rotatable shaft along a length approximately equal to the length of the stator.

3. The electric machine according to claim 1,
wherein the at least one first radial outlet is provided at one end of the dam section and the at least one second radial outlet is provided at another end of the dam section.

4. The electric machine according to claim 1, wherein the dam section further comprises at least one fin arranged inside of the axial channel.

5. The electric machine according to claim 4, wherein the at least one fin protrudes from a wall of the dam section inwardly in the axial channel.

6. The electric machine according to claim 5, comprising a set of fins, wherein the set of fins are approximately evenly distributed over the wall of the dam section.

7. The electric machine according to claim 6, wherein the at least one fin of the set of fins extends axially over at least a part of a length of the dam section.

8. The electric machine according to claim 6, wherein the at least one fin of the set of fins is arranged to be inserted through slits in the wall of the dam section.

9. The electric machine according to claim 6, wherein the set of fins comprises between 8 and 15 fins.

10. The electric machine according to claim 4, wherein the dam section further comprises multiple sets of fins, arranged axially behind each other, each having an angular displacement with respect to the adjacent set.

11. An electric or hybrid vehicle transmission comprising;
the electric machine according to claim 1;
wherein the axial channel of the rotatable shaft is arranged for connection to a cooling system of the electric or hybrid vehicle transmission to allow a cooling fluid flow into the axial channel.

12. Method for cooling of an electric machine, including:
providing an electric machine having a rotor and a stator mounted over the rotor;
providing a shaft fixedly connected to the rotor;
providing at least one first radial outlet at a first end of the shaft and at least one second radial at a second end of the shaft;
wherein the at least one first radial outlet and the at least one second radial outlet are provided on a dam section of the shaft having an increased diameter, such that cooling fluid flows out of the at least first outlet and the at least second outlet towards the stator for cooling ends of stator windings of said stator.

13. The electric machine according to claim 4, wherein the at least one fin extends axially over at least a part of a length of the dam section.

14. The electric machine according to claim 4, wherein the at least one fin is arranged to be inserted through slits in a wall of the dam section.

15. The electric machine according to claim 9, wherein the set of fins comprises 12 fins.
